(19) United States
(12) Patent Application Publication
(10) Pub. No.: US 2007/0065249 A1
(43) Pub. Date: Mar. 22, 2007

(54) Nut plate and method of making the same

(76) Inventors: Anatoly Gosis, Palatine, IL (US); Richard K. Mitts, Fullerton, CA (US); Norbert A. Markl, Placentia, CA (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/228,715

(22) Filed: Sep. 16, 2005

(51) Int. Cl. F16B 27/00

(52) U.S. Cl. 411/84

(57) ABSTRACT

A nut plate includes a weld site provided by a rivet of softer material. In making the nut plate, the rivet is inserted into a rivet hole of the nut plate and retained therein by interference fit. Final nut plate formation and rivet termination occur in a single press stroke. The nut plate and rivet are tempered together.

### FIELD OF THE INVENTION

The present invention relates generally to industrial fastener systems; and, more particularly, the invention pertains to so-called “nut plates” having rivet-like inserts establishing weld sites to secure the plate in an assembly.

### BACKGROUND OF THE INVENTION

Assemblies of various types, such as, for example, automobiles use so-called “nut plates” as part of a fastener system. Because it is sometimes difficult to access a nut or other fastener component in the completed assembly, it is known to secure the nut or other component in a fixed position for engagement with the complementary component of the fastener system, such as a bolt. Affixing a single nut can be difficult and positioning imprecise. It is known to provide the nut or simply a threaded boss, on an otherwise generally plate-like structure which can then be secured in place. It is known to secure such nut plates by welding or the like directly to frame members of the assembly, such as an automobile frame. A single nut plate can be of sufficient size to include several fastener components.

For strength in the completed assembly, it is sometimes desirable to provide the nut plate of hardened metal, such as tempered metals. A nut-like component can be provided as a protuberance or enlargement of the nut plate and threaded internally to receive and engage a bolt. Thus, the “nut” is actually part of the plate itself, all as a single monolithic body. As a single, tempered body the nut plate adds strength and rigidity to the final assembly, particularly if used with a tempered bolt.

Hardened or tempered steels often are difficult to weld satisfactorily. If the nut plate is not adequately secured to the frame to which it is attached, the overall assembly is weakened. To provide suitable welding sites in tempered nut plates, it is known to soften small areas of the tempered metal, to establish areas that are more easily welded. Localized softening of the tempered nut plate is costly and inefficient.

It also is known to provide a nut plate with rivet holes. The nut plate is manufactured completely, which may require several stamping operations, and is hardened by suitable tempering. Thereafter, a rivet-like body is inserted into the rivet hole of the completed and tempered nut plate, and the rivet is terminated. The rivet is of softer material than the nut plate itself, and establishes a site that is more suitable for welding. One or several weld sites can be provided in a nut plate using rivets of the type described.

In a known process for manufacturing nut plates with rivet-like inserts to establish weld sites, the nut plate is first pre-formed, generally by stamping, in large sheets with several nut plates connected to each other in a web-like configuration. The pre-formed plate is finished in shape, generally again in one or more additional stampings. The plate in a finished shape is tempered. Thereafter, straight body rivets are inserted manually into the tempered nut plate, and power shaped to affix the rivet in place.

While tempered nut plates provided in the manners described above have worked satisfactorily, the manufacturing thereof is cumbersome and time consuming. Multiple pressing steps are required to form the plate into its final shape, the plate is tempered, rivets are inserted by hand and a power shaper is used to terminate the rivets. The plates are transferred from a stamping shop to a tempering facility, and then back to another location for rivet insertion and termination. It has been necessary to terminate the rivets almost immediately after insertion because the rivets will otherwise fall from the rivet holes.

What is needed is a manufacturing process whereby nut plates can be made more efficiently, thereby reducing the cost for supplying nut plates.

### SUMMARY OF THE INVENTION

The present invention provides a nut plate and rivet in which the rivet is secured in a rivet hole by interference fit, with final forming and rivet termination performed in a single operation. Tempering occurs with the rivets assembled in the nut plate.

In one aspect thereof, the present invention provides a process to form a hardened nut plate with softer weld sites. The process has steps of cutting a pre-form shape of the nut plate from a first material that is hardenable by tempering, including creating a rivet hole to receive a rivet; providing a rivet of a second material having tempering characteristics different than the first material; creating an assembly by inserting the rivet into the hole; shaping the assembly including forming the plate and terminating the rivet; and tempering the assembly to harden the first material.

In another aspect thereof, the present invention provides a pre-form for a tempered nut plate, having a pre-tempered first material defining a preliminary shape of the nut plate, including a rivet hole. The first material is hardenable by subsequent tempering. A rivet of a second material less hardenable by tempering than the first material has a shank retained in the hole by an interference fit.

In a still further aspect thereof, the present invention provides a nut plate prepared for tempering. The nut plate has a first material hardenable by tempering that defines at least one rivet hole and at least one fastener site. A rivet is retained in the hole by interference fit. The rivet is made of low carbon steel.

In yet another aspect thereof, the present invention provides a process to make a nut plate with steps of creating a pre-form of the nut plate including a rivet hole; inserting a rivet into the rivet hole; terminating the rivet; forming the pre-form of the nut plate into a final shape for the nut plate; and tempering the formed nut plate with the terminated rivet therein.

An advantage of the present invention is providing a manufacturing process for nut plates having rivet-like inserts for weld locations.

Another advantage of the present invention is providing a manufacturing process for nut plates that has reduced steps and promotes manufacturing efficiency.

Still another advantage of the present invention is providing a nut plate that is produced efficiently, at low cost.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a completed nut plate in accordance with the present invention;

FIG. 2 is a perspective view of a web of pre-formed nut plates;

FIG. 3 is a perspective view similar to that of FIG. 2, but illustrating the web of pre-formed nut plates with rivets installed therein;

FIG. 4 is a perspective view of a nut plate of the present invention similar to that of FIG. 1, but illustrating a side of the nut plate opposite the side shown for the nut plate in FIG. 1;

FIG. 5 is an enlarged elevational view of a rivet in accordance with the present invention; and

FIG. 6 is a plan view of the bottom of the rivet shown in FIG. 5.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

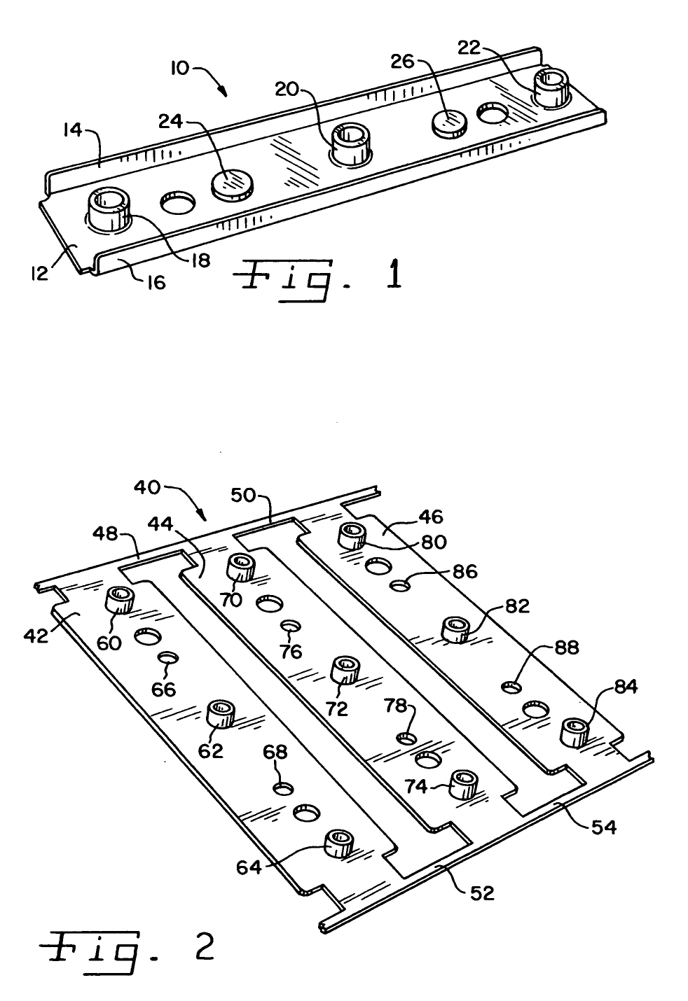

Referring now more specifically to the drawings and to FIG. 1 in particular, numeral 10 designates a nut plate in accordance with the present invention. Nut plate 10 includes a base 12 and first and second side edges 14 and 16. A plurality of fastener sites 18, 20 and 22 are provided in addition to weld sites formed from rivets 24, 26. It should be understood that the configuration of nut plate 10 is exemplary in nature only and should not be viewed as limiting of the present invention. For example, nut plates can be of different configurations, shapes and sizes, and may include more or fewer fastener sites than the three fastener sites 18, 20 and 22 shown in FIG. 1. Further, two weld sites formed by rivets 24, 26 are shown for weld plate 10, but a single rivet weld site or more than two also can be used.

Fastener sites 18, 20 and 22 are depicted as bosses having openings therethrough which can be threaded for receiving and engaging the threads of a bolt (not shown). Other types of fastener sites also can be used.

Nut plate 10 is formed from strip metal suitable for the installation and use thereof. For example, in automotive assemblies hardenable steels such as SAE1050-1095, 4130 and 4140 steels in a thickness ranging from about 0.008 inch to about 0.150 inch are suitable. From the sheet or strip of metal, a web 40 (FIG. 2) is fashioned by stamping to have a plurality of inter-connected pre-form nut plates. In FIG. 2, three pre-form nut plates 42, 44, 46 are shown in web 40. However, it should be understood that a substantially longer strip can be used to form a web having more pre-form nut plates than the three shown in FIG. 2.

Pre-form nut plates 42, 44, 46 are preliminary shapes for nut plates that are connected by links 48, 50 on one side thereof and links 52, 54 on the opposite side thereof. As can be seen in FIG. 2, pre-form nut plates 42, 44, 46 are substantially flat, except for the bosses forming fastener sites. Accordingly, pre-form nut plate 42 has fastener site bosses 60, 62, 64 and defines rivet holes 66, 68. Pre-form nut plate 44 includes fastener site bosses 70, 72, 74 and defines rivet holes 76, 78. Pre-form nut plate 46 includes fastener site bosses 80, 82, 84 and defines rivet holes 86, 88.

As those skilled in the art will understand readily, web 40 as shown in FIG. 2 can be formed by a stamping or a progressive stamping from a sheet of appropriate metal. Elongated transverse edges of pre-form nut plates 42, 44, 46 have not yet been bent to form first and second sides of the nut plates, such as sides 14 and 16 shown in FIG. 1. Accordingly, the portions of pre-form nut plates 42, 44, 46 which are the base and side sections of the finished nut plate are substantially planar.

Following creation of the pre-form nut plates in web 40 shown in FIG. 2, rivets are inserted into rivet holes 66, 68, 76, 78, 86, 88. Thus, as shown in FIG. 3 rivets 90, 92; 100, 102 and 110, 112 are inserted in rivet holes 66, 68; 76, 78 and 86, 88, respectively. Insertion can be done mechanically as web 40 advances along the production line in incremented and indexed steps.

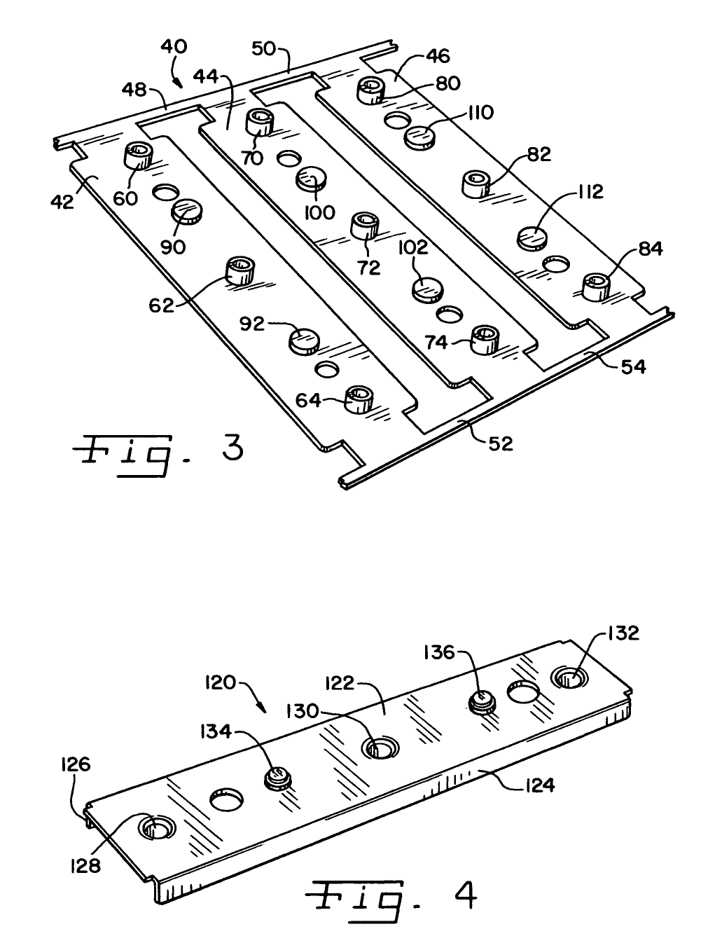

The assembly of pre-form nut plates 42, 44, 46 with rivets 90, 92, 100, 102, 110 and 112 therein is then advanced to a stamping press, where in a final press stroke the formation of individual nut plates is completed. Links 48, 50, 52 and 54 are severed, and the transverse edge portions of pre-form nut plates 42, 44 and 46 are bent to form sides such as sides 14 and 16 of nut plate 10 in FIG. 1. At the same time, in the same press stroke, rivets 90, 92, 100, 102 and 110, 112 are terminated, or rounded to secure each rivet 90, 92, 100, 102 and 110, 112 in its respective rivet hole 66, 68, 76, 78, 86, 88. A completed nut plate 120 before tempering is shown in FIG. 4. Nut plate 120 includes a base 122 and first and second side edges 124 and 126. A plurality of fastener sites 128, 130 and 132 are provided in addition to weld sites formed from rivets 134, 136. The terminated ends of rivets 134 and 136 are shown in FIG. 4.

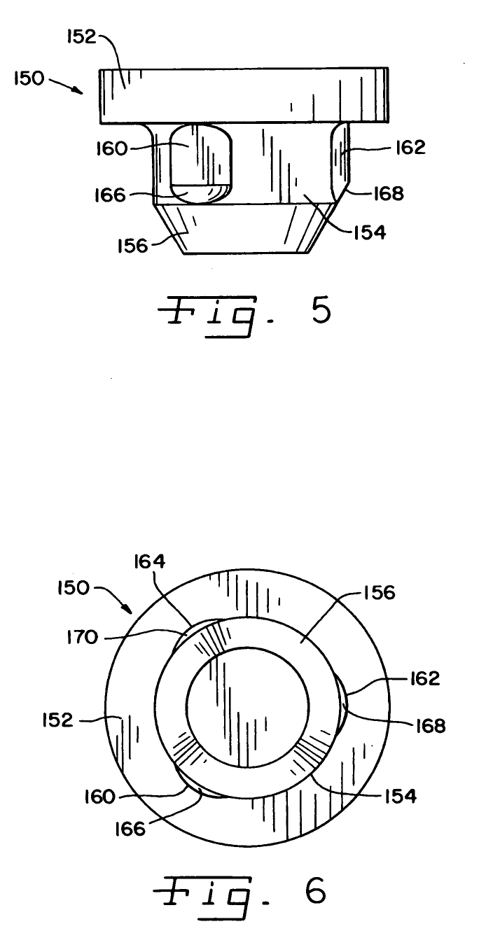

It is necessary to manipulate and handle the sub-assemblies of pre-form nut plates with rivets therein, including relatively abrupt indexing thereof as web 40 advances from a rivet inserting station to a final press wherein the rivets are terminated and the individual nut plates are finish-formed. To retain the rivets in the rivet holes, an interference relationship is provided between the rivets and rivet holes. FIGS. 5 and 6 illustrate a suitable configuration for rivets used in the present invention. Rivet 150 includes a head 152, a shank 154 and a tapered entrance end 156. Tapered entrance end 156 facilitates insertion into the rivet holes by providing a narrowed diameter lead end for insertion. Accordingly, rivet 150 is suitable for mechanical insertion and will locate in the rivet hole and self-center in the hole even if the rivet is misaligned slightly from the hole.

To retain rivet 150 in a suitable rivet hole, lobes 160, 162 and 164 are provided on shank 154. Lobes 160, 162 and 164 are spaced equally about shank 154 and define an outer circle at the peripheries thereof slightly larger than the diameter of a rivet hole in which rivet 150 is inserted. Thus, some force is required, and an interference fit relationship is established between rivet 150 and the material defining the hole in which the rivet is received. It is noted that although an insertion force is generally required, a low force (such as, for example, around 100-300 lbs) is preferred to assist in ensuring an interim positionally-stable retention until such time as the rivet is terminated by, for example, a line press. The materials selected for web 40 and rivet 150 can be chosen to provide slight deformation of either or both as a rivet is inserted in a rivet hole. Accordingly, retention of the rivet in the rivet hole is enhanced.

To facilitate insertion of rivet 150 as lobes 160, 162, 164 encounter edges of a rivet hole, tapered lead ends 166, 168 and 170 are provided on lobes 160, 162 and 164, respectively. While more or fewer lobes can be provided than the three lobes 160, 162, 164 shown in FIGS. 5 and 6, using three lobes is advantageous in that rivet 150 is then self-centering in the rivet hole in which it is received.

For the aforementioned steels used for web 40, SAE 1006-1010 steels are suitable for making the rivets. Specifically SAE 1010 nickel plated steel is suitable; however, other materials also are suitable. Typically, low carbon steels and low carbon plated steels are suitable. Electroless nickel plating approximately 0.0003″ thick is a suitable coating for corrosion protection. Copper plating, stainless steel and other materials or coatings can be used to meet requirements for a particular application of the present invention. Rivets of the present invention can be manufactured suitably by single-stroke cold heading process including the formation of lobes thereon. Less handling is required in that rivet insertion and termination occur together with the stamping or other process for formation of the nut plate, all prior to tempering.

All formation required for nut plate 120 is completed before tempering. The nut plate is finished in its final form with rivets inserted therein and the rivets terminated. Terminating the rivets is performed in the same press and at the same time as the final formation to complete the side edges and sever the pre-form nut plates from the web to provide separate and individual nut plates. Accordingly, no additional step or time is required for rivet termination. Compared to previously known techniques in which rivets were inserted by hand and terminated with powered riveters, the present invention provides improved manufacturing speed.

The completed nut plate is then transferred to a site for tempering. Austempering heat treatment is suitable for some applications of the present invention. As those skilled in the art will readily understand, austempering temperatures between 1525° F. and 1700° F. will form fine grain austenite with uniform carbon content. Quench time is controlled to avoid the formation of pearlite. Quench temperatures ranging from 450° F. to about 750° F. are controlled to prevent martensite formation. After quenching in a liquid salt bath, isothermal transformation into ausferrite commences, followed by air-cooling.

The assembled and finish-formed nut plates with rivets therein, such as nut plate 120 shown in FIG. 4, are tempered as one. Accordingly, the rivets also are subjected to the conditions for tempering. By using low carbon steels for the rivets, without undergoing carbonization to increase the carbon content, the rivets are not tempered the same as high carbon steels. Accordingly, the rivet and pre-form nut plate can be assembled and tempered together with suitable strength increase for the nut plate while the rivet forming a weld site remains suitably soft for satisfactory welding. Accordingly, following tempering, rivets 134, 136 remain softer and more suitable for welding than base 122 of nut plate 120.

The present invention allows pre-assembly of a rivet in a nut plate, with final forming of the nut plate and rivet termination occurring simultaneously in a single press stroke. Thereafter, the completed assembly can be tempered for strengthening the nut plate while retaining suitable softness in the rivet for welding. Rivets are inserted within the progressive steps of forming the nut plate, and the completed assembly is tempered thereafter. Accordingly, less handling is required than known processes in which the nut plate is formed and tempered before rivets are inserted.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A process to form a hardened nut plate with softer weld sites, said process comprising steps of:
cutting a pre-form shape of the nut plate from a first material hardenable by tempering, including creating a rivet hole to receive a rivet;
providing a rivet of a second material having tempering characteristics different than the first material;
creating an assembly by inserting the rivet into the hole;
shaping the assembly including forming the plate and terminating the rivet; and
tempering the assembly to harden the first material.

2. The process of claim 1, said inserting including forcibly inserting the rivet and establishing an interference fit between the rivet and the rivet hole.

3. The process of claim 1, including providing at least one lobe on at least one of the rivet and an edge of the first material defining the rivet hole.

4. The process of claim 3, including providing three lobes on at least one of the rivet and an edge of the first material defining the rivet hole.

5. The process of claim 4, including providing the lobes on the rivet.

6. A pre-form for a tempered nut plate, comprising:
a pre-tempered first material defining a preliminary shape of the nut plate, including a rivet hole, said first material being hardenable by subsequent tempering; and
a rivet of a second material less hardenable by tempering than said first material, said rivet having a shank retained in said hole by an interference fit.

7. The pre-form of claim 6, said first material being a hardenable steel.

8. The pre-form of claim 6, said second material being a low carbon steel.

9. The pre-form of claim 8, said first material being a hardenable steel.

10. The pre-form of claim 9, said shank having three lobes thereon.

11. The pre-form of claim 1, said shank having three lobes thereon.

12. A nut plate prepared for tempering, said nut plate comprising:
a first material hardenable by tempering, said material defining at least one rivet hole and at least one fastener site; and
a rivet retained in said hole by interference fit, said rivet being made of low carbon steel.

13. The nut plate of claim 12, said rivet having a terminated entrance end.

14. The nut plate of claim 13, said rivet having a shank and three lobes on said shank.

15. The nut plate of claim 12, said rivet having a shank and three lobes on said shank.

16. A process to make a nut plate, comprising:
creating a pre-form of the nut plate including a rivet hole;
inserting a rivet into the rivet hole;
terminating the rivet;
forming the pre-form of the nut plate into a final shape for the nut plate; and
tempering the formed nut plate with the terminated rivet therein.

17. The process of claim 16, said inserting including forcibly inserting the rivet and creating an interference fit of the rivet in the hole.

18. The process of claim 17, including providing a rivet having a shank with three lobes.

19. The process of claim 16, said steps of terminating and forming being conducted substantially simultaneously.

20. The process of claim 16, said step of tempering being austempering.
